(19) United States
(12) Patent Application Publication
(10) Pub. No.: US 2015/0350678 A1
(43) Pub. Date: Dec. 3, 2015

(54) IMAGE ENCODING METHOD, IMAGE DECODING METHOD, IMAGE ENCODING APPARATUS, IMAGE DECODING APPARATUS, IMAGE ENCODING PROGRAM, IMAGE DECODING PROGRAM, AND RECORDING MEDIA

(71) Applicant: NIPPON TELEGRAPH AND TELEPHONE CORPORATION, Tokyo (JP)

(72) Inventors: Shinya SHIMIZU, Yokosuka-shi (JP); Shiori SUGIMOTO, Yokosuka-shi (JP); Hideaki KIMATA, Yokosuka-shi (JP); Akira KOJIMA, Yokosuka-shi (JP)

(73) Assignee: NIPPON TELEGRAPH AND TELEPHONE CORPORATION, Tokyo (JP)

(21) Appl. No.: 14/654,920

(22) PCT Filed: Dec. 20, 2013
(86) PCT No.: PCT/JP2013/084377

§ 371 Date: Jun. 23, 2015

(30) Foreign Application Priority Data
Dec. 27, 2012 (JP) 2012-284694

(51) Int. Cl. H04N 19/597; H04N 19/119; G06T 7/00; H04N 19/182; H04N 13/00; H04N 19/52; H04N 19/176

(52) U.S. Cl. CPC H04N 19/597; H04N 19/52; H04N 19/119; H04N 19/176; H04N 19/182; H04N 13/0022; G06T 7/0044; G06T 2207/10016

(57) ABSTRACT

When pseudo motion representing synthesized positional deviation in a view-synthesized image is compensated for, pseudo motion-compensated prediction of fractional pixel precision for the view-synthesized image is realized. An image encoding/decoding method which performs encoding/decoding while predicting an image between views using a reference image for a view different from that of a processing target image and a depth map for the processing target image when a multi-view image including images of a plurality of different views is encoded/decoded includes: setting a pseudo motion vector indicating a region on a depth map for a processing target region obtained by dividing the processing target image; setting the region on the depth map indicated by the pseudo motion vector as a depth region; generating depth information serving as a processing target region depth for a pixel of an integer or fractional position within the depth region corresponding to a pixel of an integer pixel position within the processing target region using depth information of an integer pixel position of the depth map; and generating an inter-view predicted image for the processing target region using the processing target region depth and the reference image.

### TECHNICAL FIELD

The present invention relates to an image encoding method, an image decoding method, an image encoding apparatus, an image decoding apparatus, an image encoding program, an image decoding program, and recording media for encoding and decoding a multi-view image.

Priority is claimed on Japanese Patent Application No. 2012-284694, filed Dec. 27, 2012, the content of which is incorporated herein by reference.

### BACKGROUND ART

Conventionally, multi-view images each including a plurality of images obtained by photographing the same object and background using a plurality of cameras are known. A moving image captured by the plurality of cameras is referred to as a multi-view moving image (multi-view video). In the following description, an image (moving image) captured by one camera is referred to as a “two-dimensional image (moving image)”, and a group of two-dimensional images (two-dimensional moving images) obtained by photographing the same object and background using a plurality of cameras differing in a position and/or direction (hereinafter referred to as a view) is referred to as a “multi-view image (multi-view moving image)”.

A two-dimensional moving image has a high correlation in relation to a time direction and coding efficiency can be improved by using the correlation. On the other hand, when cameras are synchronized, frames (images) corresponding to the same time of videos of the cameras in a multi-view image or a multi-view moving image are frames (images) obtained by photographing the object and background in completely the same state from different positions, and thus there is a high correlation between the cameras. It is possible to improve coding efficiency by using the correlation in coding of a multi-view image or a multi-view moving image.

Here, conventional technology relating to coding technology of two-dimensional moving images will be described. In many conventional two-dimensional moving-image coding schemes including H.264, MPEG-2, and MPEG-4, which are international coding standards, highly efficient encoding is performed using technologies of motion-compensated prediction, orthogonal transform, quantization, and entropy encoding. For example, in H.264, encoding using a temporal correlation with a plurality of past or future frames is possible.

Details of the motion-compensated prediction technology used in H.264, for example, are disclosed in Non-Patent Document 1. An outline of the motion-compensated prediction technology used in H.264 will be described. The motion-compensated prediction of H.264 enables an encoding target frame to be divided into blocks of various sizes and enables the blocks to have different motion vectors and different reference frames. Using a different motion vector in each block, highly precise prediction which compensates for a different motion of a different object is realized. On the other hand, prediction having high precision considering occlusion caused by a temporal change is realized using a different reference frame in each block.

Next, a conventional coding scheme for multi-view images or multi-view moving images will be described. A difference between the multi-view image coding scheme and the multi-view moving-image coding scheme is that a correlation in the time direction is simultaneously present in a multi-view moving image in addition to the correlation between the cameras. However, the same method using the correlation between the cameras can be used in both cases. Therefore, a method to be used in coding multi-view moving images will be described here.

In order to use the correlation between the cameras in the coding of multi-view moving images, there is a conventional scheme of encoding a multi-view moving image with high efficiency through “disparity-compensated prediction”, in which motion-compensated prediction is applied to images captured by different cameras at the same time. Here, the disparity is a difference between positions at which the same portion on an object is present on image planes of cameras arranged at different positions. FIG. 10 is a conceptual diagram illustrating the disparity occurring between the cameras. In the conceptual diagram illustrated in FIG. 10, image planes of cameras having parallel optical axes face down vertically. In this manner, the positions at which the same portion on the object are projected on the image planes of the different cameras are generally referred to as corresponding points.

In the disparity-compensated prediction, each pixel value of an encoding target frame is predicted from a reference frame based on the corresponding relationship, and a prediction residual thereof and disparity information representing the corresponding relationship are encoded. Because the disparity varies for every pair of target cameras and positions of the target cameras, it is necessary to encode disparity information for each region in which the disparity-compensated prediction is performed. Actually, in the multi-view moving-image coding scheme of H.264, a vector representing the disparity information is encoded for each block using the disparity-compensated prediction.

The corresponding relationship provided by the disparity information can be represented as a one-dimensional amount representing a three-dimensional position of an object, rather than a two-dimensional vector, based on epipolar geometric constraints by using camera parameters. Although there are various representations as information representing the three-dimensional position of the object, the distance from a reference camera to the object or a coordinate value on an axis which is not parallel to an image plane of the camera is normally used. It is to be noted that the reciprocal of the distance may be used instead of the distance. In addition, because the reciprocal of the distance is information proportional to the disparity, two reference cameras may be set and a three-dimensional position may be represented as the amount of disparity between images captured by the cameras. Because there is no essential difference regardless of what expression is used, information representing a three-dimensional position is hereinafter expressed as a depth without such expressions being distinguished.

FIG. 11 is a conceptual diagram of epipolar geometric constraints. According to the epipolar geometric constraints, a point on an image of another camera corresponding to a point on an image of a certain camera is constrained to a straight line called an epipolar line. At this time, when a depth for a pixel of the image is obtained, a corresponding point is uniquely defined on the epipolar line. For example, as illustrated in FIG. 11, a corresponding point in an image of a second camera for the object projected at a position m in an image of a first camera is projected at a position m′ on the epipolar line when the position of the object in a real space is M′ and projected at a position m″ on the epipolar line when the position of the object in the real space is M″.

In Non-Patent Document 2, a highly precise predicted image is generated and efficient multi-view moving-image coding is realized by using this property and synthesizing a predicted image for an encoding target frame from a reference frame in accordance with three-dimensional information of each object given by a depth map (distance image) for the reference frame. It is to be noted that the predicted image generated based on the depth is referred to as a view-synthesized image, a view-interpolated image, or a disparity-compensated image.

However, because epipolar geometry follows a simple camera model, there is some error compared to a projection model of an actual camera. In addition, because it is difficult to exactly obtain camera parameters for an actual image in accordance with the simple camera model, it is impossible to avoid the error. Furthermore, even when the camera model is exactly obtained, it is impossible to generate an exact view-synthesized image or disparity-compensated image because it is also difficult to correctly obtain the depth for an actually captured image as well as to encode and transmit the actually captured image without distortion.

In Non-Patent Document 3, it is possible to handle a generated view-synthesized image as a reference frame similar to other reference frames by inserting the generated view-synthesized image into a decoded picture buffer (DPB). Thereby, even when the encoding target image and the view-synthesized image are slightly deviated due to an influence of the above-described error, highly precise image prediction which compensates for the deviation is realized by setting and encoding a vector indicating the deviation on the view-synthesized image.

### PRIOR ART DOCUMENTS

### Non-Patent Documents

Non-Patent Document 1: ITU-T Recommendation H.264 (March 2009), “Advanced video coding for generic audiovisual services”, March 2009.

Non-Patent Document 2: Shinya SHIMIZU, Masaki KITAHARA, Kazuto KAMIKURA, and Yoshiyuki YASHIMA, “Multi-view Video Coding based on 3-D Warping with Depth Map”, In Proceedings of Picture Coding Symposium 2006, SS3-6, April 2006.

Non-Patent Document 3: Ervin Martinian, Alexander Behrens, Jun Xin, Anthony Vetro, and Huifang Sun, “Extensions of H.264/AVC for Multiview Video Compression”, MERL Technical Report. TR2006-048, June, 2006.

### SUMMARY OF INVENTION

### Problems to be Solved by the Invention

With the method disclosed in Non-Patent Document 3, it is possible to handle positional deviation in a view-synthesized image as pseudo motion and compensates for the pseudo motion while using a general motion-compensated prediction process by changing only a management portion of the DPB. Thereby, it is possible to compensate for positional deviation from an encoding target image occurring in the view-synthesized image due to various factors and improve prediction efficiency using the view-synthesized image for an actual image.

However, because the view-synthesized image is handled like a normal reference image, there is a problem in that it is necessary to generate a view-synthesized image for one image and thus a processing amount is increased even when the view-synthesized image is referred to for only part of the encoding target image.

Although it is also possible to generate the view-synthesized image only for a necessary region by using a depth for the encoding target image, pixel values of the view-synthesized image for a plurality of integer pixels are necessary to interpolate a pixel value for one fractional pixel when a pseudo motion vector indicating a fractional pixel position is given. That is, there is a problem in that it is necessary to generate a view-synthesized image for pixels greater in number than prediction target pixels and thus it is impossible to solve the problem of the increase in the processing amount.

The present invention has been made in view of such circumstances, and an object thereof is to provide an image encoding method, an image decoding method, an image encoding apparatus, an image decoding apparatus, an image encoding program, an image decoding program, and recording media that enable pseudo motion-compensated prediction of fractional pixel precision for a view-synthesized image with small computational complexity while preventing prediction efficiency of an image signal from being significantly deteriorated when pseudo motion is compensated for on the view-synthesized image.

### Means for Solving the Problems

The present invention is an image encoding apparatus which performs encoding while predicting an image between different views using a reference image encoded for a view different from that of an encoding target image and a depth map for the encoding target image when a multi-view image including images of a plurality of different views is encoded, and the image encoding apparatus includes: a pseudo motion vector setting unit which sets a pseudo motion vector indicating a region on the depth map for an encoding target region obtained by dividing the encoding target image; a depth region setting unit which sets the region on the depth map indicated by the pseudo motion vector as a depth region; a reference region depth generating unit which generates depth information serving as a reference region depth for a pixel of an integer or fractional position within the depth region corresponding to a pixel of an integer pixel position within the encoding target region using depth information of an integer pixel position of the depth map; and an inter-view prediction unit which generates an inter-view predicted image for the encoding target region using the reference region depth and the reference image.

The present invention is an image encoding apparatus which performs encoding while predicting an image between views using a reference image encoded for a view different from that of an encoding target image and a depth map for the encoding target image when a multi-view image including images of a plurality of different views is encoded, and the image encoding apparatus includes: a fractional pixel precision depth information generating unit which generates depth information for a pixel of a fractional pixel position in the depth map to obtain a fractional pixel precision depth map; a view-synthesized image generating unit which generates a view-synthesized image for pixels of integer and fractional pixel positions of the encoding target image using the fractional pixel precision depth map and the reference image; a pseudo motion vector setting unit which sets a pseudo motion vector of fractional pixel precision indicating a region on the view-synthesized image for an encoding target region obtained by dividing the encoding target image; and an inter-view prediction unit which designates image information for the region on the view-synthesized image indicated by the pseudo motion vector as an inter-view predicted image.

The present invention is an image encoding apparatus which performs encoding while predicting an image between different views using a reference image encoded for a view different from that of an encoding target image and a depth map for the encoding target image when a multi-view image including images of a plurality of different views is encoded, and the image encoding apparatus includes: a pseudo motion vector setting unit which sets a pseudo motion vector indicating a region on the encoding target image for an encoding target region obtained by dividing the encoding target image; a reference region depth setting unit which sets depth information for a pixel on the depth map corresponding to a pixel within the encoding target region as a reference region depth; and an inter-view prediction unit which generates an inter-view predicted image for the encoding target region for the region indicated by the pseudo motion vector using the reference image assuming that a depth of the region indicated by the pseudo motion vector is the reference region depth.

The present invention is an image decoding apparatus which performs decoding while predicting an image between different views using a reference image decoded for a view different from that of a decoding target image and a depth map for the decoding target image when the decoding target image is decoded from encoded data of a multi-view image including images of a plurality of different views, and the image decoding apparatus includes: a pseudo motion vector setting unit which sets a pseudo motion vector indicating a region on the depth map for a decoding target region obtained by dividing the decoding target image; a depth region setting unit which sets the region on the depth map indicated by the pseudo motion vector as a depth region; a decoding target region depth generating unit which generates depth information serving as a decoding target region depth for a pixel of an integer or fractional position within the depth region corresponding to a pixel of an integer pixel position within the decoding target region using depth information of an integer pixel position of the depth map; and an inter-view prediction unit which generates an inter-view predicted image for the decoding target region using the decoding target region depth and the reference image.

Preferably, in the image decoding apparatus of the present invention, the inter-view prediction unit generates the inter-view predicted image using a disparity vector obtained from the decoding target region depth.

Preferably, in the image decoding apparatus of the present invention, the inter-view prediction unit generates the inter-view predicted image using a disparity vector obtained from the decoding target region depth and the pseudo motion vector.

Preferably, in the image decoding apparatus of the present invention, the inter-view prediction unit sets, for each of predicted regions obtained by dividing the decoding target region, a disparity vector for the reference image using depth information within a region corresponding to each of the predicted regions on the decoding target region depth and generates the inter-view predicted image for the decoding target region by generating a disparity-compensated image using the disparity vector and the reference image.

Preferably, the image decoding apparatus of the present invention further includes: a disparity vector storing unit which stores the disparity vector; and a disparity predicting unit which generates predicted disparity information in a region adjacent to the decoding target region using the stored disparity vector.

Preferably, the image decoding apparatus of the present invention further includes a correction disparity vector unit which sets a correction disparity vector which is a vector for correcting the disparity vector, wherein the inter-view prediction unit generates the inter-view predicted image by generating a disparity-compensated image using the reference image and a vector which is obtained by correcting the disparity vector using the correction disparity vector.

Preferably, the image decoding apparatus of the present invention further includes: a correction disparity vector storing unit which stores the correction disparity vector; and a disparity predicting unit which generates predicted disparity information in a region adjacent to the decoding target region using the stored correction disparity vector.

Preferably, in the image decoding apparatus of the present invention, the decoding target region depth generating unit designates depth information for a pixel of a peripheral integer pixel position as depth information for a pixel of a fractional pixel position within the depth region.

The present invention is an image decoding apparatus which performs decoding while predicting an image between different views using a reference image decoded for a view different from that of a decoding target image and a depth map for the decoding target image when the decoding target image is decoded from encoded data of a multi-view image including images of a plurality of different views, and the image decoding apparatus includes: a pseudo motion vector setting unit which sets a pseudo motion vector indicating a region on the decoding target image for a decoding target region obtained by dividing the decoding target image; a decoding target region depth setting unit which sets depth information for a pixel on the depth map corresponding to a pixel within the decoding target region as a decoding target region depth; and an inter-view prediction unit which generates an inter-view predicted image for the decoding target region for the region indicated by the pseudo motion vector using the reference image assuming that a depth of the region indicated by the pseudo motion vector is the decoding target region depth.

Preferably, in the image decoding apparatus of the present invention, the inter-view prediction unit sets, for each of predicted regions obtained by dividing the decoding target region, a disparity vector for the reference image using depth information within a region corresponding to each of the predicted regions on the decoding target region depth and generates the inter-view predicted image for the decoding target region by generating a disparity-compensated image using the pseudo motion vector, the disparity vector, and the reference image.

Preferably, the image decoding apparatus of the present invention further includes: a reference vector storing unit which stores a reference vector for the reference image in the decoding target region indicated using the disparity vector and the pseudo motion vector; and a disparity predicting unit which generates predicted disparity information in a region adjacent to the decoding target region using the stored reference vector.

The present invention is an image encoding method which performs encoding while predicting an image between different views using a reference image encoded for a view different from that of an encoding target image and a depth map for the encoding target image when a multi-view image including images of a plurality of different views is encoded, and the image encoding method includes: a pseudo motion vector setting step of setting a pseudo motion vector indicating a region on the depth map for an encoding target region obtained by dividing the encoding target image; a depth region setting step of setting the region on the depth map indicated by the pseudo motion vector as a depth region; a reference region depth generating step of generating depth information serving as a reference region depth for a pixel of an integer or fractional position within the depth region corresponding to a pixel of an integer pixel position within the encoding target region using depth information of an integer pixel position of the depth map; and an inter-view prediction step of generating an inter-view predicted image for the encoding target region using the reference region depth and the reference image.

The present invention is an image encoding method which performs encoding while predicting an image between different views using a reference image encoded for a view different from that of an encoding target image and a depth map for the encoding target image when a multi-view image including images of a plurality of different views is encoded, and the image encoding method includes: a pseudo motion vector setting step of setting a pseudo motion vector indicating a region on the encoding target image for an encoding target region obtained by dividing the encoding target image; a reference region depth setting step of setting depth information for a pixel on the depth map corresponding to a pixel within the encoding target region as a reference region depth; and an inter-view prediction step of generating an inter-view predicted image for the encoding target region for the region indicated by the pseudo motion vector using the reference image assuming that a depth of the region indicated by the pseudo motion vector is the reference region depth.

The present invention is an image decoding method which performs decoding while predicting an image between different views using a reference image decoded for a view different from that of a decoding target image and a depth map for the decoding target image when the decoding target image is decoded from encoded data of a multi-view image including images of a plurality of different views, and the image decoding method includes: a pseudo motion vector setting step of setting a pseudo motion vector indicating a region on the depth map for a decoding target region obtained by dividing the decoding target image; a depth region setting step of setting the region on the depth map indicated by the pseudo motion vector as a depth region; a decoding target region depth generating step of generating depth information serving as a decoding target region depth for a pixel of an integer or fractional position within the depth region corresponding to a pixel of an integer pixel position within the decoding target region using depth information of an integer pixel position of the depth map; and an inter-view prediction step of generating an inter-view predicted image for the decoding target region using the decoding target region depth and the reference image.

The present invention is an image decoding method which performs decoding while predicting an image between different views using a reference image decoded for a view different from that of a decoding target image and a depth map for the decoding target image when the decoding target image is decoded from encoded data of a multi-view image including images of a plurality of different views, and the image decoding method includes: a pseudo motion vector setting step of setting a pseudo motion vector indicating a region on the decoding target image for a decoding target region obtained by dividing the decoding target image; a decoding target region depth setting step of setting depth information for a pixel on the depth map corresponding to a pixel within the decoding target region as a decoding target region depth; and an inter-view prediction step of generating an inter-view predicted image for the decoding target region for the region indicated by the pseudo motion vector using the reference image assuming that a depth of the region indicated by the pseudo motion vector is the decoding target region depth.

The present invention is an image encoding program for causing a computer to execute the image encoding method.

The present invention is an image decoding program for causing a computer to execute the image decoding method.

### Advantageous Effects of the Invention

The present invention has an advantageous effect in that it is possible to omit a process of generating a view-synthesized image for pixels greater in number than prediction target pixels and generate the view-synthesized image with small computational complexity by changing a pixel position and/or depth in generation of the view-synthesized image in accordance with a designated fractional pixel position when motion-compensated prediction of fractional pixel precision for the view-synthesized image is performed.

### BRIEF DESCRIPTION OF DRAWINGS

FIG. 1 is a block diagram illustrating a configuration of an image encoding apparatus in an embodiment of the present invention.

FIG. 2 is a flowchart illustrating an operation of the image encoding apparatus 100 illustrated in FIG. 1.

FIG. 3 is a block diagram illustrating a modified example of the image encoding apparatus 100 illustrated in FIG. 1.

FIG. 4 is a flowchart illustrating a processing operation of a process of generating an inter-camera predicted image illustrated in FIG. 2.

FIG. 5 is a block diagram illustrating a configuration of an image decoding apparatus in an embodiment of the present invention.

FIG. 6 is a flowchart illustrating an operation of the image decoding apparatus 200 illustrated in FIG. 5.

FIG. 7 is a block diagram illustrating a modified example of the image decoding apparatus 200 illustrated in FIG. 5.

FIG. 8 is a block diagram illustrating a hardware configuration when the image encoding apparatus 100 is constituted of a computer and a software program.

FIG. 9 is a block diagram illustrating a hardware configuration when the image decoding apparatus 200 is constituted of a computer and a software program.

FIG. 10 is a conceptual diagram of a disparity which occurs between cameras.

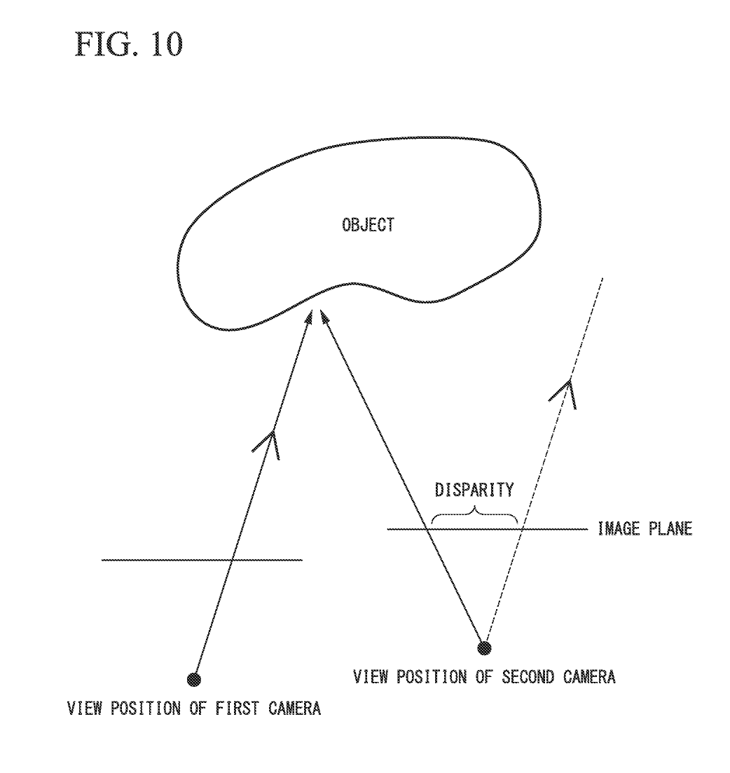

FIG. 11 is a conceptual diagram of epipolar geometric constraints.

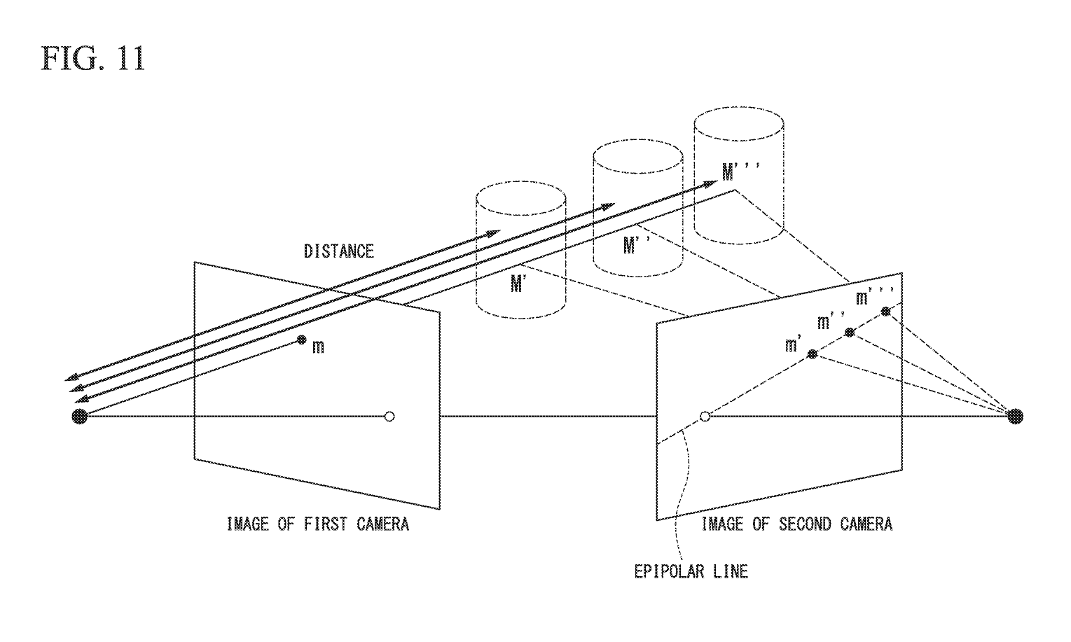

### MODES FOR CARRYING OUT THE INVENTION

Hereinafter, an image encoding apparatus and an image decoding apparatus in accordance with embodiments of the present invention will be described with reference to the drawings. In the following description, the case in which a multi-view image captured by two cameras including a first camera (referred to as a camera A) and a second camera (referred to as a camera B) is encoded is assumed and an image of the camera B is encoded or decoded using an image of the camera A as a reference image. It is to be noted that information necessary for obtaining a disparity from depth information is assumed to be separately given. Specifically, this information includes external parameters representing a positional relationship of the cameras A and B or internal parameters representing projection information for image planes by the cameras; however, other information in other forms may be given as long as a disparity is obtained from depth information. A detailed description relating to these camera parameters, for example, is disclosed in a document <Olivier Faugeras, “Three-Dimensional Computer Vision”, pp. 36-39, MIT Press; BCTC/UFF-006.37 F259 1993, ISBN: 0-262-06158-9>. This document provides a description relating to parameters representing a positional relationship of a plurality of cameras and parameters representing projection information for an image plane by a camera.

In the following description, information (a coordinate value or an index that can be associated with the coordinate value) capable of specifying a position that is interposed between symbols [ ] is added to an image, a video frame, or a depth map to represent an image signal sampled by a pixel of the position or a depth therefor. In addition, a coordinate value or a block at a position obtained by shifting a coordinate value or a block by an amount of a vector is represented by adding an index value that can be associated with the coordinate value or the block to the vector. Further, when a disparity or pseudo motion vector for a certain region a is vec, a region corresponding to the region a is represented as a+vec.

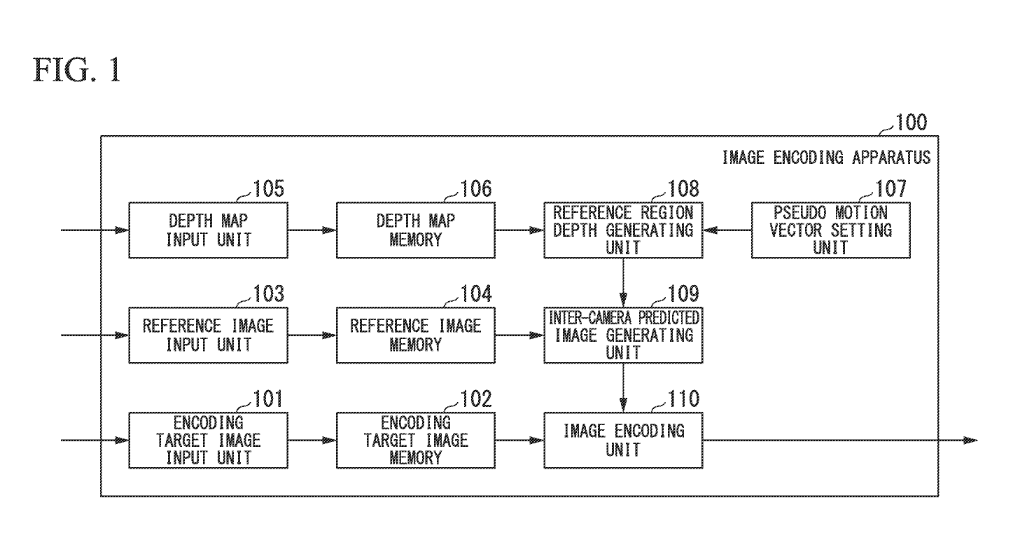

FIG. 1 is a block diagram illustrating a configuration of an image encoding apparatus in the present embodiment. As illustrated in FIG. 1, the image encoding apparatus 100 includes an encoding target image input unit 101, an encoding target image memory 102, a reference image input unit 103, a reference image memory 104, a depth map input unit 105, a depth map memory 106, a pseudo motion vector setting unit 107, a reference region depth generating unit 108, an inter-camera predicted image generating unit 109, and an image encoding unit 110.

The encoding target image input unit 101 inputs an image serving as an encoding target. Hereinafter, the image serving as the encoding target is referred to as an encoding target image. Here, an image of the camera B is assumed to be input. In addition, a camera (here, the camera B) capturing the encoding target image is referred to as an encoding target camera. The encoding target image memory 102 stores the input encoding target image. The reference image input unit 103 inputs an image to be referred to when an inter-camera predicted image (view-synthesized image or disparity-compensated image) is generated. Hereinafter, the image input here is referred to as a reference image. Here, an image of the camera A is assumed to be input. The reference image memory 104 stores the input reference image. Here, the camera (here, the camera A) capturing the reference image is referred to as a reference camera.

The depth map input unit 105 inputs a depth map to be referred to when the inter-camera predicted image is generated. Here, the depth map for the encoding target image is input. It is to be noted that the depth map indicates a three-dimensional position of an object shown in a pixel of the corresponding image. As long as the three-dimensional position is obtained using information such as separately given camera parameters, any information may be used as a depth map. For example, it is possible to use the distance from a camera to an object, a coordinate value for an axis which is not parallel to an image plane, or a disparity amount for another camera (for example, the camera A). In addition, it is only necessary to obtain a disparity amount, a disparity map directly representing the disparity amount, rather than the depth map, may be used. It is to be noted that although the depth map is given in the form of an image, the depth map may not be given in the form of an image as long as similar information can be obtained. The depth map memory 106 stores the input depth map.

The pseudo motion vector setting unit 107 sets a pseudo motion vector on the depth map for each of blocks obtained by dividing the encoding target image. The reference region depth generating unit 108 generates a reference region depth which is depth information to be used when an inter-camera predicted image is generated for each of the blocks obtained by dividing the encoding target image using the depth map and the pseudo motion vector. The inter-camera predicted image generating unit 109 obtains a corresponding relationship between a pixel of the encoding target image and a pixel of the reference image using the reference region depth and generates an inter-camera predicted image for the encoding target image. The image encoding unit 110 performs predictive encoding of the encoding target image using the inter-camera predicted image and outputs a bitstream.

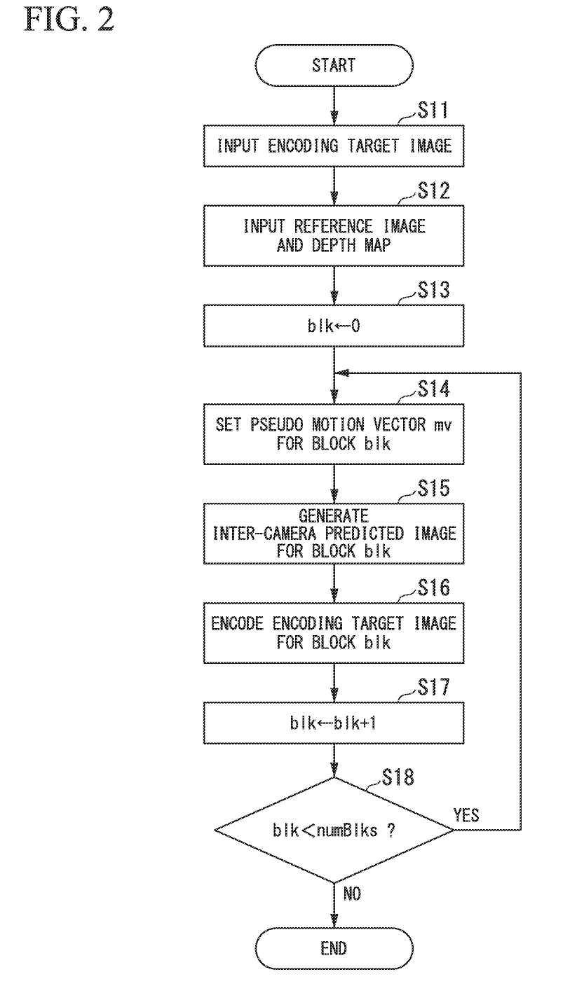

Next, an operation of the image encoding apparatus 100 illustrated in FIG. 1 will be described with reference to FIG. 2. FIG. 2 is a flowchart illustrating the operation of the image encoding apparatus 100 illustrated in FIG. 1. First, the encoding target image input unit 101 inputs an encoding target image and stores it in the encoding target image memory 102 (step S11). Next, the reference image input unit 103 inputs a reference image and stores it in the reference image memory 104. In parallel therewith, the depth map input unit 105 inputs a depth map and stores it in the depth map memory 106 (step S12).

It is to be noted that the reference image and the depth map input in step S12 are assumed to be the same as those to be obtained by a decoding end, such as a reference image and a depth map obtained by performing decoding on an already encoded reference image and depth map. This is because the occurrence of coding noise such as a drift is suppressed by using exactly the same information as that obtained by a decoding apparatus. However, when this occurrence of coding noise is allowed, a reference image and a depth map obtained by only an encoding end, such as a reference image and a depth map before encoding, may be input. In relation to the depth map, for example, a depth map estimated by applying stereo matching or the like to a multi-view image decoded for a plurality of cameras, a depth map estimated using a decoded disparity vector or motion vector or the like can be used as a depth map to be equally obtained by the decoding end, in addition to a depth map obtained by performing decoding on an already encoded depth map.

Next, the image encoding apparatus 100 encodes the encoding target image while creating an inter-camera predicted image for each of the blocks obtained by dividing the encoding target image. That is, after a variable blk indicating an index of each of the blocks obtained by dividing the encoding target image is initialized to 0 (step S13), the following process (steps S14 to S16) is iterated until blk reaches numBlks (step S18) while blk is incremented by 1 (step S17). It is to be noted that numBlks indicates the number of unit blocks on which an encoding process is performed in the encoding target image.

In the process to be performed for each block of the encoding target image, first, the pseudo motion vector setting unit 107 sets a pseudo motion vector my representing pseudo motion of the block blk on the depth map (step S14). The pseudo motion indicates positional deviation (error) occurring when a corresponding point is obtained using depth information in accordance with epipolar geometry. Here, although the pseudo motion vector may be set using any method, the same pseudo motion vector needs to be obtained on the decoding end.

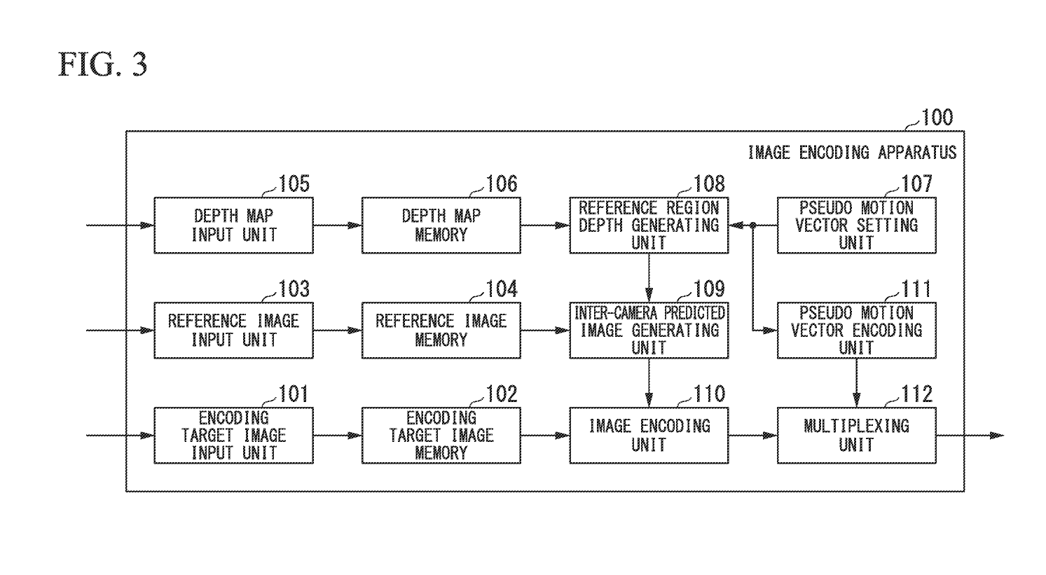

For example, an arbitrary vector may be set as the pseudo motion vector by estimating positional deviation or the like, the set pseudo motion vector may be encoded, and the decoding end may be notified of an encoded pseudo motion vector. In this case, as illustrated in FIG. 3, it is only necessary for the image encoding apparatus 100 to further include a pseudo motion vector encoding unit 111 and a multiplexing unit 112. FIG. 3 is a block diagram illustrating a modified example of the image encoding apparatus 100 illustrated in FIG. 1. The pseudo motion vector encoding unit 111 encodes a pseudo motion vector set by the pseudo motion vector setting unit 107. The multiplexing unit 112 multiplexes a bitstream of the pseudo motion vector and a bitstream of the encoding target image and outputs a multiplexed bitstream.

It is to be noted that a global pseudo motion vector may be set for each unit that is larger than a block, such as a frame or slice, and the set global pseudo motion vector may be used as a pseudo motion vector for a block within the frame or slice, rather than setting and encoding a pseudo motion vector for each block. In this case, the global pseudo motion vector is set before the process to be performed for each block, and the step (step S14) of setting the pseudo motion vector for each block is skipped.

Although any vector may be set as the pseudo motion vector, it is necessary to perform setting so that an error between an inter-camera predicted image to be generated in a subsequent process using the set pseudo motion vector and the encoding target image is reduced so as to achieve high coding efficiency. In addition, if the set pseudo motion vector is encoded, a vector for minimizing the error between the inter-camera predicted image and the encoding target image as well as a rate distortion cost to be calculated from a bit amount of the pseudo motion vector may be set as the pseudo motion vector.

Returning to FIG. 2, the reference region depth generating unit 108 and the inter-camera predicted image generating unit 109 then generate an inter-camera predicted image for the block blk (step S15). The process here will be described in detail later.

After the inter-camera predicted image is obtained, the image encoding unit 110 then performs predictive encoding on the encoding target image using the inter-camera predicted image as a predicted image and outputs a result (step S16). A bitstream obtained as a result of the encoding serves as an output of the image encoding apparatus 100. It is to be noted that as long as decoding can be correctly performed in the decoding end, any method may be used in encoding.

In general moving-image coding or image coding such as MPEG-2, H.264, or JPEG, encoding is performed by, for each block, generating a difference signal between an encoding target image and a predicted image, performing frequency transform such as a discrete cosine transform (DCT) on a difference image, and sequentially applying processes of quantization, binarization, and entropy encoding on a resultant value.

It is to be noted that although an inter-camera predicted image is used in all blocks as a predicted image in the present embodiment, an image generated using a different method for a different block may be used as the predicted image. In this case, the decoding end must be capable of determining a method with which an image used as the predicted image is generated. For example, as in H.264, information indicating a method (mode, vector information, or the like) for generating the predicted image may be encoded and the encoded information may be included in a bitstream so that a determination can be made on the decoding end.

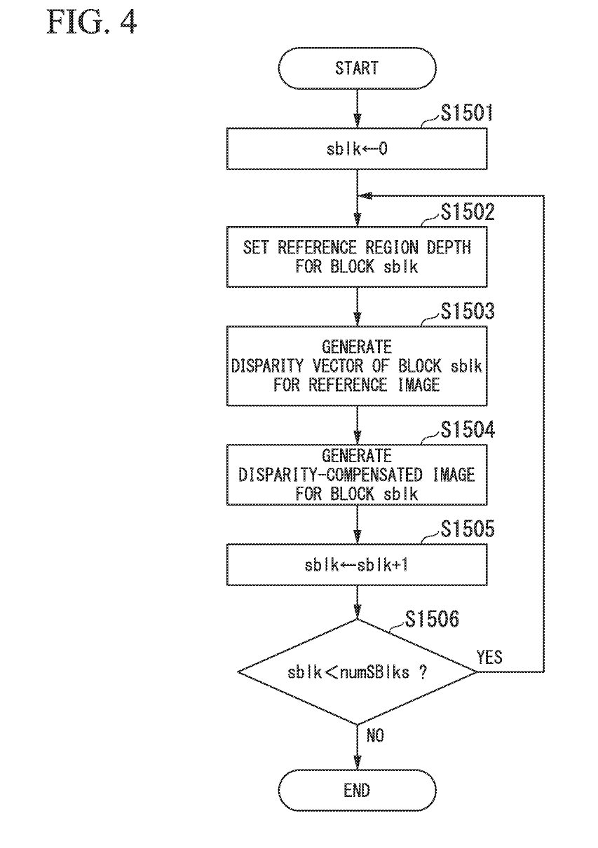

Next, processing operations of the reference region depth generating unit 108 and the inter-camera predicted image generating unit 109 illustrated in FIG. 1 will be described with reference to FIG. 4. FIG. 4 is a flowchart illustrating a processing operation of a process (step S15) of generating an inter-camera predicted image for the block blk illustrated in FIG. 2. The process here is performed for sub-blocks obtained by sub-dividing a block. That is, after a variable sblk indicating an index of a sub-block is initialized to 0 (step S1501), the following process (steps S1502 to S1504) is iterated until sblk reaches numSBlks (step S1506) while sblk is incremented by 1 (step S1505). Here, numSBlks represents the number of sub-blocks within the block blk.

It is to be noted that although the size and the shape of a sub-block may be any size and any shape, the same sub-block division is required to be obtained in the decoding end. For example, a predetermined division may be used so that each sub-block has length×width of 2 pixels×2 pixels, 4 pixels×4 pixels, or 8 pixels×8 pixels. It is to be noted that 1 pixel×1 pixel (that is, for each pixel) or the same size (that is, there is no division) as that of the block blk may be used as the predetermined division.

As another method using the same sub-block division as that of the decoding end, a sub-block division method may be encoded and a notification of the method may be provided to the decoding end. In this case, a bitstream for the sub-block division method is multiplexed with a bitstream of an encoding target image and becomes part of a bitstream to be output by the image encoding apparatus 100. It is to be noted that when the sub-block division method is selected, it is possible to generate a high-quality predicted image in a small processing amount in accordance with a process of generating an inter-camera predicted image to be described below by selecting a method in which pixels included in one sub-block have the same disparity as much as possible for the reference image and a block is divided into as few sub-blocks as possible. Also, in this case, information indicating the sub-block division is decoded from the bitstream in the decoding end and the sub-block division is performed in accordance with a method based on the decoded information.

As still another method, the sub-block division may be determined from depths for a block blk+mv on the depth map indicated by the pseudo motion vector my set in step S14. For example, it is possible to obtain the sub-block division by clustering the depths of the block blk+mv of the depth map. In addition, a division in which depths are most correctly classified may be selected from predetermined division types, rather than performing clustering. When division other than a predetermined division is used, it is necessary to perform a process of determining a sub-block division and set numSBlks in accordance with the sub-block division prior to step S1501.

In a process to be performed for each sub-block, first, one depth value is set for the sub-block sblk using the depth map and the pseudo motion vector my (step S1502). Specifically, a pixel group on the depth map corresponding to a pixel group within the sub-block sblk is obtained and one depth value is determined and set using depth values for the pixel group. It is to be noted that a pixel on the depth map for a pixel p within the sub-block is given as p+mv.

Any method can be used as a method for determining one depth value from depth values for a pixel group within a sub-block. However, it is necessary to use the same method as that of the decoding end. For example, any one of an average value, a maximum value, a minimum value, and a median value of the depth values for the pixel group within the sub-block may be used. In addition, any one of an average value, a maximum value, a minimum value, and a median value of depth values for pixels of four vertices of the sub-block may be used. Further, a depth value in a specific position (top left, center, or the like) of the sub-block may be used. When only depth values for part of the pixels within the sub-block are used, pixels or depth values on the depth map for the other pixels may not be obtained.

It is to be noted that because the corresponding pixel p+mv on the depth map is present at a fractional pixel position when the pseudo motion vector mv indicates a fractional pixel, there is no corresponding depth value in data of the depth map. In this case, the depth value may be generated by an interpolation process using depth values for integer pixels around p+mv. In addition, p+mv may be rounded to an integer pixel position, and a depth value for a pixel at the peripheral integer pixel position may be used without change, rather than performing interpolation.

When the depth value is obtained for the sub-block sblk, then a disparity vector dv between the reference image and the encoding target image corresponding to the depth value is obtained (step S1503). The conversion from the depth value into the disparity vector is performed in accordance with the given depth and the definition of camera parameters. For example, when a relationship between a pixel on an image and a three-dimensional point is defined as in Formula (1), the disparity vector dv is represented by Formula (2).

$$\begin{matrix}[ Formula 1 ] & \\ d ( \begin{matrix}m \\ 1\end{matrix} ) = A [ R \vert t ] ( \begin{matrix}g \\ 1\end{matrix} ) & ( 1 ) \\ [ Formula 2 ] & \\ s ( \begin{matrix}q + dv \\ 1\end{matrix} ) = {A}_{r} ( {R}_{r} {R}_{c}^{- 1} ( {A}_{c}^{- 1} {d}_{q} ( \begin{matrix}q \\ 1\end{matrix} ) - {t}_{c} ) + {t}_{r} ) & ( 2 )\end{matrix}$$

It is to be noted that in denotes a column vector representing a two-dimensional coordinate value of the pixel, g denotes a column vector representing a coordinate value of the corresponding three-dimensional point, d denotes the depth value representing the distance from a camera to an object, A denotes a 3×3 matrix which is referred to as an internal parameter of the camera, R denotes a 3×3 matrix representing rotation which is one of external parameters of the camera, and t denotes a three-dimensional column vector representing translation which is one of the external parameters of the camera. In addition, [R|t] denotes a 3×4 matrix in which R and t are arranged. In addition, subscripts of the camera parameters A, R, and t denote cameras, r denotes a reference camera, and c denotes an encoding target camera. In addition, q denotes a coordinate value on an encoding target image, d_{q} denotes the distance from the encoding target camera to the object corresponding to the depth value obtained in step S1502, and s denotes a scalar quantity which satisfies the formula.

It is to be noted that the coordinate value q on the encoding target image may be necessary to obtain the disparity vector, as shown in Formula (2). At this time, as q, a coordinate value of the sub-block sblk may be used or a coordinate value of a block corresponding to the sub-block sblk through the pseudo motion vector my may be used. It is to be noted that a coordinate value of a predetermined position such as the upper left or center of the block can be used as the coordinate value for the block. That is, when the coordinate value of the sub-block sblk is denoted as pos, pos or pos+mv may be used as q.

In addition, because the direction of a disparity depends upon arrangement of cameras and a disparity amount depends upon a depth value regardless of the position of a sub-block when the arrangement of the cameras is one-dimensionally parallel, it is possible to obtain a disparity vector from the depth value with reference to a lookup table created in advance.

Next, a disparity-compensated image for the sub-block sblk is generated using the obtained disparity vector dv and the reference image (step S1504). In the process here, a method similar to conventional disparity-compensated prediction or pseudo motion-compensated prediction can be used except that the given vector and the reference image are used. Here, the disparity vector of the sub-block sblk for the reference image may be set to dv or it may be set to dv+mv.

When the position of the sub-block is used as the coordinate value on the encoding target image in step S1503 and dv is used as the disparity vector of the sub-block for the reference image in step S1504, this corresponds to a process of performing inter-camera prediction on the assumption that the sub-block has a depth indicated by the pseudo motion vector mv. That is, when deviation occurs between the encoding target image and the depth map, it is possible to realize inter-camera prediction in which the deviation has been compensated for.

In addition, when the position corresponding to the sub-block through the pseudo motion vector my is used as the coordinate value on the encoding target image in step S1503 and dv+mv is used as the disparity vector of the sub-block for the reference image in step S1504, this corresponds to a process of performing inter-camera prediction on the assumption that a region on the reference image corresponding to a region indicated by the pseudo motion vector my through the depth corresponds to the sub-block. That is, it is possible to perform prediction by compensating for deviation corresponding to the pseudo motion vector my generated by various factors such as a projection model error in an inter-camera predicted image generated on the assumption that there is no positional deviation between the encoding target image and the depth map.

It is to be noted that it is possible for the present embodiment to reduce the number of pixels of the inter-camera predicted image to be generated upon generating an ultimate predicted image for one pixel as compared to a conventional technique of compensating for deviation caused by various factors such as a projection model error after generating an inter-camera predicted image for all pixels of the encoding target image on the assumption that there is no positional deviation between the encoding target image and the depth map. Specifically, when a deviation corresponding to a fractional pixel is generated, in order to generate a predicted image for a fractional pixel of a position at which the deviation has been compensated for, it is necessary for the conventional technique to generate an inter-camera predicted image for a plurality of integer pixels around the position. In contrast, it is possible for the present embodiment to directly generate an inter-camera predicted image for a fractional pixel of a position at which the deviation has been compensated for.

Further, when the position corresponding to the sub-block through the pseudo motion vector mv is used as the coordinate value on the encoding target image in step S1503 and dv is used as the disparity vector for the reference image of the sub-block in step S1504, this corresponds to a process of performing inter-camera prediction on the assumption that a disparity vector in the sub-block is equal to a disparity vector in a region indicated by the pseudo motion vector mv. That is, it is possible to perform inter-camera prediction while compensating for an error occurring in the depth map within a single object.

In addition, when the position of the sub-block is used as the coordinate value on the encoding target image in step S1503 and dv+mv is used as the disparity vector of the sub-block for the reference image in step S1504, this corresponds to a process of performing inter-camera prediction on the assumption that a disparity vector in the sub-block is equal to a disparity vector in a region indicated by the pseudo motion vector mv and a region on the reference image corresponding to a region indicated by the pseudo motion vector my corresponds to the sub-block. That is, it is possible to perform prediction while compensating for an error occurring in the depth map within a single object and deviation caused by various factors such as a projection model error.

The process realized by steps S1503 and S1504 is one embodiment of a process of generating an inter-camera predicted image when one depth value is given for a sub-block sblk. In the present invention, another method may be used as long as an inter-camera predicted image can be generated from one depth value given for the sub-block. For example, a corresponding region (which is not required to have the same shape and/or size as the sub-block) on the reference image may be identified on the assumption that the sub-block belongs to one depth plane, and the inter-camera predicted image may be generated by warping the reference image for the corresponding region. In addition, the inter-camera predicted image may be generated by warping, for the sub-block, an image for a corresponding region on the reference image of a block obtained by shifting the sub-block by a pseudo motion vector.

In addition, in order to correct an error occurring in, for example, modeling of a projection model of a camera, parallelization (rectification) of a multi-view image, estimation of camera parameters and/or an error of a depth value in further detail, a correction vector cv on the reference image may be used in addition to the above-described disparity vector. In this case, in step S1504, dv+cv is used in place of the disparity vector dv. It is to be noted that any vector may be used as the correction vector, and it is possible to use minimization of an error between the inter-camera predicted image and the encoding target image in the encoding target region and/or a rate distortion cost in the encoding target region in order to set an efficient correction vector.

As long as the same correction vector is obtained in the decoding end, an arbitrary vector may be used. For example, the arbitrary vector may be set, the vector may be encoded, and the decoding end may be notified of the encoded vector. When the vector is encoded and transmitted, although encoding and transmission may be performed for each sub-block sblk, it is possible to reduce a bit amount necessary for the encoding by setting one correction vector for each block blk.

It is to be noted that when the correction vector is encoded, a vector is decoded at an appropriate timing (for each sub-block or each block) from the bitstream in the decoding end and the decoded vector is used as the correction vector.

When information on a used inter-camera predicted image is stored for each block or sub-block, information indicating that a view-synthesized image using the depth has been referred to may be stored, or information used when the inter-camera predicted image is actually generated may be stored. It is to be noted that the stored information is referred to when another block or another frame is encoded or decoded. For example, when vector information (a vector to be used in disparity-compensated prediction or the like) for a certain block is encoded or decoded, predicted vector information may be generated from vector information stored for an already encoded block around the block, and only the difference from the predicted vector information may be encoded or decoded.

As the information indicating that the view-synthesized image using a depth has been referred to, corresponding prediction mode information may be stored, information corresponding to an inter-frame prediction mode may be stored as the prediction mode, and reference frame information corresponding to the view-synthesized image may be stored as a reference frame at that time. In addition, as vector information, the pseudo motion vector my may be stored or the pseudo motion vector my and the correction vector cv may be stored.

As the information used when the inter-camera predicted image is actually generated, the information corresponding to the inter-frame prediction mode may be stored as the prediction mode, and the reference image may be stored as the reference frame at that time. In addition, the disparity vector dv or the corrected disparity vector dv+cv may be stored for each sub-block as the vector information. It is to be noted that there are cases in which two or more disparity vectors are used within a sub-block such as a case in which warping or the like is used. In such cases, all disparity vectors may be stored or one disparity vector may be selected and stored for each sub-block in accordance with a predetermined method. As a method for selecting one disparity vector, for example, there is a method for selecting a disparity vector having a maximum disparity amount, a method for selecting a disparity vector in a specific position (upper left or the like) of the sub-blocks.

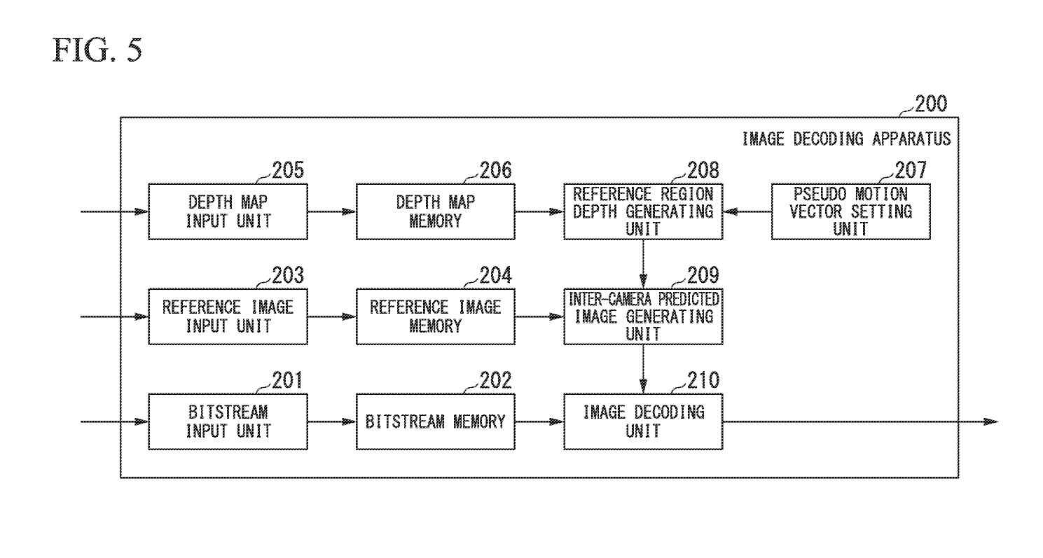

Next, an image decoding apparatus will be described. FIG. 5 is a block diagram illustrating a configuration of the image decoding apparatus in the present embodiment. As shown in FIG. 5, the image decoding apparatus 200 includes a bitstream input unit 201, a bitstream memory 202, a reference image input unit 203, a reference image memory 204, a depth map input unit 205, a depth map memory 206, a pseudo motion vector setting unit 207, a reference region depth generating unit 208, an inter-camera predicted image generating unit 209, and an image decoding unit 210.

The bitstream input unit 201 inputs a bitstream for an image serving as a decoding target. Hereinafter, the image serving as the decoding target is referred to as a decoding target image. Here, an image of the camera B is indicated. In addition, a camera (here, the camera B) capturing the decoding target image is hereinafter referred to as a decoding target camera. The bitstream memory 202 stores the input bitstream for the decoding target image. The reference image input unit 203 inputs an image to be referred to when an inter-camera predicted image (view-synthesized image or disparity-compensated image) is generated. Hereinafter, the image input here is referred to as a reference image. Here, an image of the camera A is assumed to be input. The reference image memory 204 stores the input reference image. Hereinafter, a camera (here, the camera A) capturing the reference image is referred to as a reference camera.

The depth map input unit 205 inputs a depth map to be referred to when the inter-camera predicted image is generated. Here, the depth map for the decoding target image is assumed to be input. It is to be noted that the depth map represents a three-dimensional position of an object shown in each pixel of a corresponding image. As long as the three-dimensional position is obtained from information such as separately given camera parameters, the depth map may be any information. For example, it is possible to use the distance from a camera to the object, a coordinate value for an axis which is not parallel to an image plane, or a disparity amount for another camera (for example, the camera A). In addition, because it is only necessary to obtain the disparity amount here, a disparity map directly representing disparity amounts, rather than the depth map, may be used. It is to be noted that although the depth map is given in the form of an image here, the depth map need not be given in the form of an image as long as similar information is obtained. The depth map memory 206 stores the input depth map.

The pseudo motion vector setting unit 207 sets a pseudo motion vector on the depth map for each of blocks obtained by dividing the decoding target image. The reference region depth generating unit 208 generates a reference region depth which is depth information to be used when the inter-camera predicted image is generated for each of the blocks obtained by dividing the decoding target image using the depth map and the pseudo motion vector. The inter-camera predicted image generating unit 209 obtains a corresponding relationship between a pixel of the decoding target image and a pixel of the reference image using the reference region depth and generates an inter-camera predicted image for the decoding target image. The image decoding unit 210 decodes the decoding target image from the bitstream using the inter-camera predicted image and outputs the decoded image.

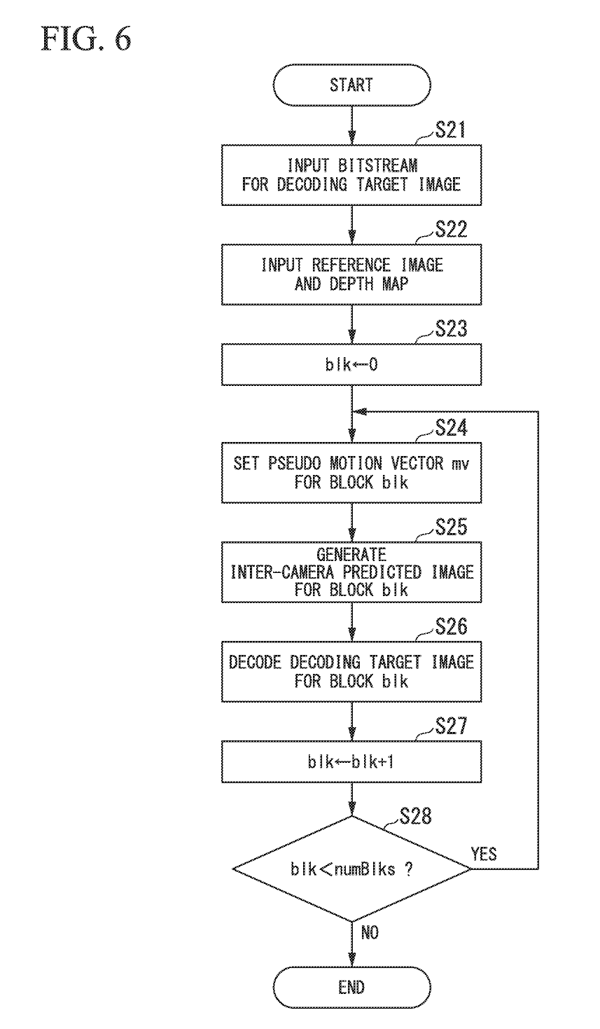

Next, an operation of the image decoding apparatus 200 illustrated in FIG. 5 will be described with reference to FIG. 6. FIG. 6 is a flowchart illustrating the operation of the image decoding apparatus 200 illustrated in FIG. 5. First, the bitstream input unit 201 inputs a bitstream obtained by encoding a decoding target image and stores it in the bitstream memory 202 (step S21). In parallel therewith, the reference image input unit 203 inputs a reference image and stores it in the reference image memory 204. In addition, the depth map input unit 205 inputs a depth map and stores it in the depth map memory 206 (step S22).

It is to be noted that the reference image and the depth map input in step S22 are assumed to be the same as those used in the encoding end. This is because the occurrence of coding noise such as a drift is suppressed by using exactly the same information as that used by the encoding apparatus. However, when this occurrence of coding noise is allowed, a reference image and a depth map that are different from those used at the time of encoding may be input. In relation to the depth map, a depth map estimated by applying stereo matching or the like to a multi-view image decoded for a plurality of cameras, a depth map estimated using a decoded disparity vector or pseudo motion vector or the like, or the like can be used in addition to a separately decoded depth map.

Next, the image decoding apparatus 200 decodes the decoding target image from the bitstream while creating an inter-camera predicted image for each of blocks obtained by dividing the decoding target image. That is, after a variable blk indicating an index of each of the blocks obtained by dividing the decoding target image is initialized to 0 (step S23), the following process (steps S24 to S26) is iterated until blk reaches numBlks (step S28) while blk is incremented by 1 (step S27). It is to be noted that numBlks represents the number of unit blocks on which a decoding process is performed in the decoding target image.

In the process to be performed for each of the blocks of the decoding target image, first, the pseudo motion vector setting unit 207 sets a pseudo motion vector my representing pseudo motion of the block blk on the depth map (step S24). The pseudo motion refers to positional deviation (error) occurring when a corresponding point has been obtained using depth information in accordance with epipolar geometry. Here, although the pseudo motion vector may be set using any method, the same pseudo motion vector as that used in the encoding end must be obtained.

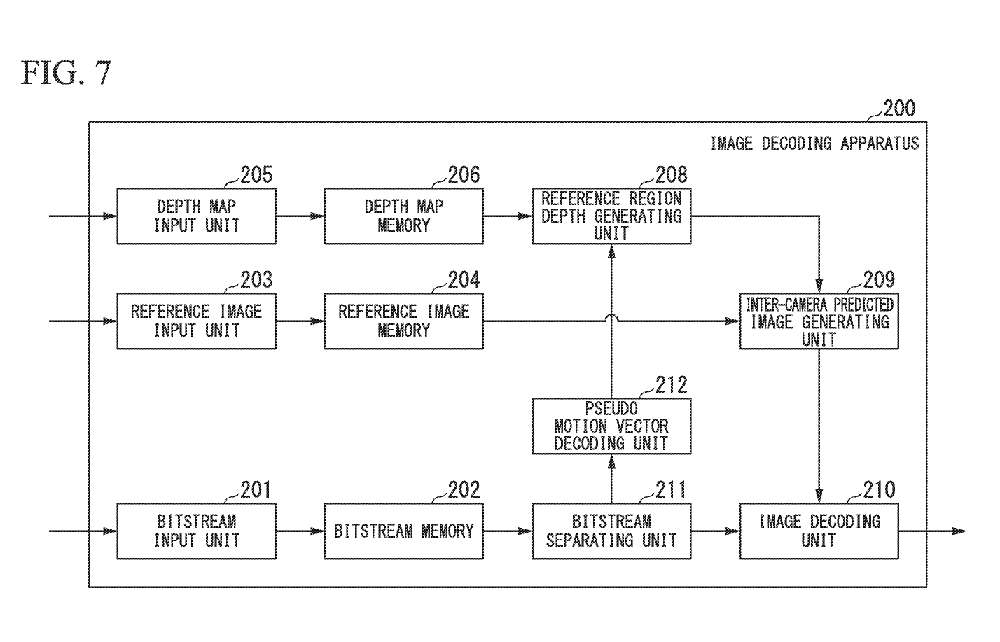

For example, when a pseudo motion vector used at the time of encoding is multiplexed into the bitstream, the vector may be decoded and set as the pseudo motion vector mi. In this case, as illustrated in FIG. 7, it is only necessary for the image decoding apparatus 200 to include a bitstream separating unit 211 and a pseudo motion vector decoding unit 212 in place of the pseudo motion vector setting unit 207. FIG. 7 is a block diagram illustrating a modified example of the image decoding apparatus 200 illustrated in FIG. 5. The bitstream separating unit 211 separates and outputs a bitstream for the pseudo motion vector and a bitstream for the decoding target image from the input bitstream. The pseudo motion vector decoding unit 212 decodes the pseudo motion vector used at the time of encoding from the bitstream for the pseudo motion vector and the reference region depth generating unit 208 is notified of the decoded pseudo motion vector.

It is to be noted that a global pseudo motion vector may be set for each unit that is larger than a block such as a frame or slice, rather than setting a pseudo motion vector for each block, and the set global pseudo motion vector may be used as a pseudo motion vector for blocks within the frame or slice. In this case, the global pseudo motion vector is set before a process to be performed for each block, and the step (step S24) of setting the pseudo motion vector for each block is skipped.

Next, the reference region depth generating unit 208 and the inter-camera predicted image generating unit 209 generate an inter-camera predicted image for the block blk (step S25). Because the process here is the same as the above-described step S15 illustrated in FIG. 2, a detailed description thereof is omitted.

When the inter-camera predicted image has been obtained, the image decoding unit 210 then decodes the decoding target image from the bitstream while using the inter-camera predicted image as a predicted image and outputs the decoded image (step S26). The resultant decoded image serves as an output of the image decoding apparatus 200. It is to be noted that as long as the bitstream can be correctly decoded, any method may be used in decoding. In general, a method corresponding to that used at the time of encoding is used.

When the encoding is performed in accordance with general moving-image encoding or image encoding such as MPEG-2, H.264, or MEG, the decoding is performed by, for each block, performing entropy decoding, inverse binarization, inverse quantization, and the like, obtaining a predictive residual signal by performing inverse frequency transform such as an inverse discrete cosine transform (IDCT), adding a predicted image, and clipping the resultant image in the range of a pixel value.

It is to be noted that although the present embodiment uses an inter-camera predicted image as a predicted image in all blocks, an image generated by a different method for a different block may be used as a predicted image. In this case, it is necessary to determine a method with which the image used as the predicted image is generated and use an appropriate predicted image. For example, when information indicating a method (mode, vector information, or the like) for generating the predicted image is encoded and included in a bitstream as in H.264, the decoding may be performed by decoding the information and selecting an appropriate predicted image. It is to be noted that it is possible to omit a process (steps S24 and S25) related to generation of the inter-camera predicted image for a block for which the inter-camera predicted image is not used as the predicted image.

In addition, although a process of encoding and decoding one frame has been described above in the foregoing description, the present embodiment can also be applied to moving-image coding by iterating the process for a plurality of frames. In addition, the present embodiment is also applicable to some frames or some blocks of moving images. Further, although configurations and processing operations of the image encoding apparatus and the image decoding apparatus have been described above in the foregoing description, it is possible to realize the image encoding method and the image decoding method of the present invention in accordance with processing operations corresponding to operations of units of the image encoding apparatus and the image decoding apparatus.

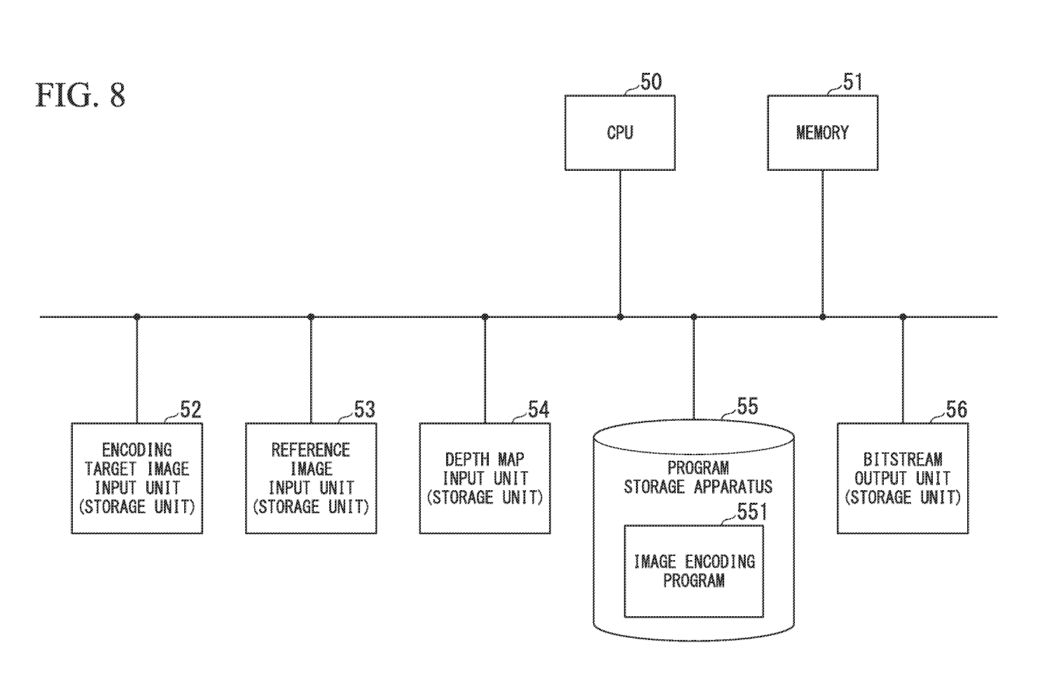

FIG. 8 is block diagram illustrating a hardware configuration when the above-described image encoding apparatus 100 is constituted of a computer and a software program. The system illustrated in FIG. 8 has a configuration in which a central processing unit (CPU) 50 which executes the program, a memory 51 such as a random access memory (RAM) which stores the program and data to be accessed by the CPU 50, an encoding target image input unit 52 (which may be a storage unit such as a disk apparatus which stores an image signal) which inputs an encoding target image signal from a camera or the like, a reference image input unit 53 (which may be a storage unit such as a disk apparatus which stores an image signal) which inputs an reference target image signal from a camera or the like, a depth map input unit 54 (which may be a storage unit such as a disk apparatus which stores a depth map) which inputs a depth map from a depth camera or the like for a camera capturing the encoding target image, a program storage apparatus 55 which stores an image encoding program 551 which is a software program for causing the CPU 50 to execute the image encoding process described as the embodiment of the present invention, and a bitstream output unit 56 (which may be a storage unit such as a disk apparatus which stores a bitstream) which outputs a bitstream generated by executing the image encoding program 551 loaded by the CPU 50 to the memory 51, for example, via a network are connected through a bus.

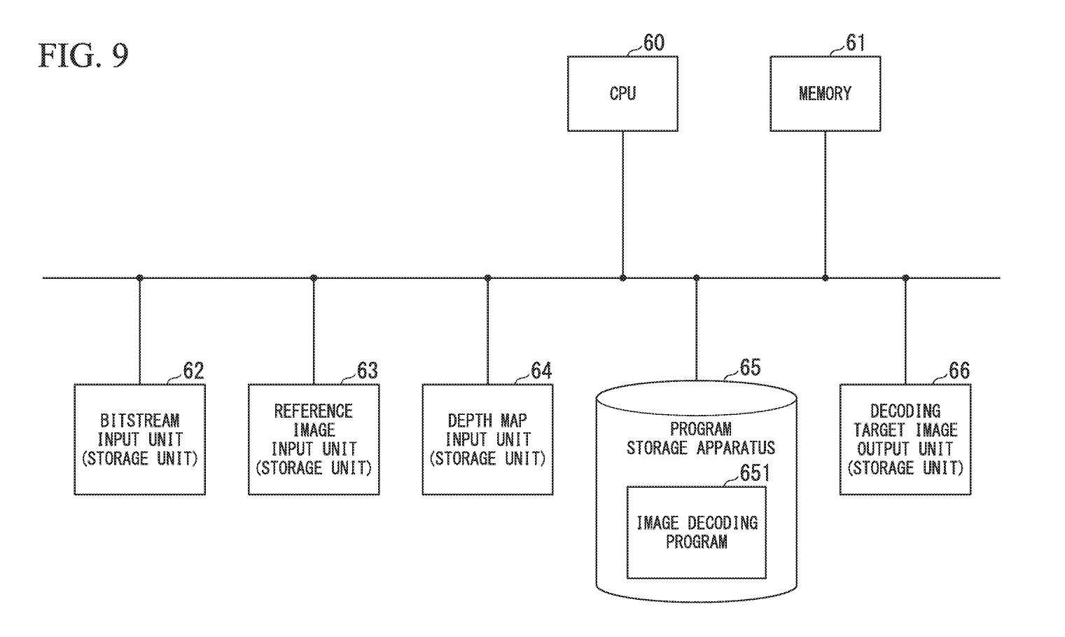

FIG. 9 is a block diagram illustrating a hardware configuration when the above-described image decoding apparatus 200 is constituted of a computer and a software program. The system illustrated in FIG. 9 has a configuration in which a CPU 60 which executes the program, a memory 61 such as a RAM which stores the program and data to be accessed by the CPU 60, a bitstream input unit 62 (which may be a storage unit such as a disk apparatus which stores an image signal) which inputs a bitstream encoded by the image encoding apparatus in accordance with the present technique, a reference image input unit 63 (which may be a storage unit such as a disk apparatus which stores an image signal) which inputs a reference target image signal from a camera or the like, a depth map input unit 64 (which may be a storage unit such as a disk apparatus which stores depth information) which inputs a depth map from a depth camera or the like for a camera capturing the decoding target, a program storage apparatus 65 which stores an image decoding program 651 which is a software program for causing the CPU 60 to execute the image decoding process described as the embodiment of the present invention, and a decoding target image output unit 66 (which may be a storage unit such as a disk apparatus which stores an image signal) which outputs a decoding target image obtained by performing decoding on the bitstream through execution of the image decoding program 651 loaded to the memory 61 by the CPU 60 to a reproduction apparatus or the like are connected through a bus.

In addition, the image encoding process and the image decoding process may be executed by recording a program for realizing functions of the processing units in the image encoding apparatus illustrated in FIGS. 1 and 3 and the image decoding apparatus illustrated in FIGS. 5 and 7 on a computer-readable recording medium and causing a computer system to read and execute the program recorded on the recording medium. It is to be noted that the “computer system” used here includes an operating system (OS) and hardware such as peripheral devices. In addition, the “computer system” also includes a World Wide Web (WWW) system which is provided with a homepage providing environment (or displaying environment). In addition, the “computer-readable recording medium” refers to a storage apparatus including a portable medium such as a flexible disk, a magneto-optical disc, a read only memory (ROM), or a compact disc (CD)-ROM, and a hard disk embedded in the computer system. Furthermore, the “computer-readable recording medium” also includes a medium that holds a program for a constant period of time, such as a volatile memory (RAM) inside a computer system serving as a server or a client when the program is transmitted via a network such as the Internet or a communication circuit such as a telephone circuit.

In addition, the program may be transmitted from a computer system storing the program in a storage apparatus or the like to another computer system via a transmission medium or transmission waves in the transmission medium. Here, the “transmission medium” for transmitting the program refers to a medium having a function of transmitting information, such as a network (communication network) like the Internet or a communication circuit (communication line) like a telephone circuit. In addition, the program may be a program for realizing part of the above-described functions. Further, the program may be a program, i.e., a so-called differential file (differential program), capable of realizing the above-described functions in combination with a program already recorded on the computer system.

While an embodiment of the present invention has been described above with reference to the drawings, it is apparent that the embodiments are exemplary of the present invention and the present invention is not limited to the embodiment. Accordingly, additions, omissions, substitutions, and other modifications of constituent elements may be made without departing from the technical idea and scope of the present invention.

### INDUSTRIAL APPLICABILITY

The present invention is applicable for essential use in achieving high coding efficiency with small computational complexity even when noise is included in a depth map or the like when inter-camera prediction is performed on an encoding (decoding) target image using a depth map for the encoding (decoding) target image.

### DESCRIPTION OF REFERENCE SIGNS

101 Encoding target image input unit
102 Encoding target image memory
103 Reference image input unit
104 Reference image memory
105 Depth map input unit
106 Depth map memory
107 Pseudo motion vector setting unit
108 Reference region depth generating unit
109 Inter-camera predicted image generating unit
110 Image encoding unit
111 Pseudo motion vector encoding unit
112 Multiplexing unit
201 Bitstream input unit
202 Bitstream memory
203 Reference image input unit
204 Reference image memory
205 Depth map input unit
206 Depth map memory
207 Pseudo motion vector setting unit
208 Reference region depth generating unit
209 Inter-camera predicted image generating unit
210 Image decoding unit
211 Bitstream separating unit
212 Pseudo motion vector decoding unit

1. An image encoding apparatus which performs encoding while predicting an image between different views using a reference image encoded for a view different from that of an encoding target image and a depth map for the encoding target image when a multi-view image including images of a plurality of different views is encoded, the image encoding apparatus comprising:
a pseudo motion vector setting unit which sets a pseudo motion vector indicating a region on the depth map for an encoding target region obtained by dividing the encoding target image;
a depth region setting unit which sets the region on the depth map indicated by the pseudo motion vector as a depth region;
a reference region depth generating unit which generates depth information serving as a reference region depth for a pixel of an integer or fractional position within the depth region corresponding to a pixel of an integer pixel position within the encoding target region using depth information of an integer pixel position of the depth map; and
an inter-view prediction unit which generates an inter-view predicted image for the encoding target region using the reference region depth and the reference image.

2. An image encoding apparatus which performs encoding while predicting an image between views using a reference image encoded for a view different from that of an encoding target image and a depth map for the encoding target image when a multi-view image including images of a plurality of different views is encoded, the image encoding apparatus comprising:
a fractional pixel precision depth information generating unit which generates depth information for a pixel of a fractional pixel position in the depth map to obtain a fractional pixel precision depth map;
a view-synthesized image generating unit which generates a view-synthesized image for pixels of integer and fractional pixel positions of the encoding target image using the fractional pixel precision depth map and the reference image;
a pseudo motion vector setting unit which sets a pseudo motion vector of fractional pixel precision indicating a region on the view-synthesized image for an encoding target region obtained by dividing the encoding target image; and
an inter-view prediction unit which designates image information for the region on the view-synthesized image indicated by the pseudo motion vector as an inter-view predicted image.

3. An image encoding apparatus which performs encoding while predicting an image between different views using a reference image encoded for a view different from that of an encoding target image and a depth map for the encoding target image when a multi-view image including images of a plurality of different views is encoded, the image encoding apparatus comprising:
a pseudo motion vector setting unit which sets a pseudo motion vector indicating a region on the encoding target image for an encoding target region obtained by dividing the encoding target image;
a reference region depth setting unit which sets depth information for a pixel on the depth map corresponding to a pixel within the encoding target region as a reference region depth; and
an inter-view prediction unit which generates an inter-view predicted image for the encoding target region for the region indicated by the pseudo motion vector using the reference image assuming that a depth of the region indicated by the pseudo motion vector is the reference region depth.

4. An image decoding apparatus which performs decoding while predicting an image between different views using a reference image decoded for a view different from that of a decoding target image and a depth map for the decoding target image when the decoding target image is decoded from encoded data of a multi-view image including images of a plurality of different views, the image decoding apparatus comprising:
a pseudo motion vector setting unit which sets a pseudo motion vector indicating a region on the depth map for a decoding target region obtained by dividing the decoding target image;
a depth region setting unit which sets the region on the depth map indicated by the pseudo motion vector as a depth region;
a decoding target region depth generating unit which generates depth information serving as a decoding target region depth for a pixel of an integer or fractional position within the depth region corresponding to a pixel of an integer pixel position within the decoding target region using depth information of an integer pixel position of the depth map; and
an inter-view prediction unit which generates an inter-view predicted image for the decoding target region using the decoding target region depth and the reference image.

5. The image decoding apparatus according to claim 4, wherein the inter-view prediction unit generates the inter-view predicted image using a disparity vector obtained from the decoding target region depth.

6. The image decoding apparatus according to claim 4, wherein the inter-view prediction unit generates the inter-view predicted image using a disparity vector obtained from the decoding target region depth and the pseudo motion vector.

7. The image decoding apparatus according to claim 4, wherein the inter-view prediction unit sets, for each of predicted regions obtained by dividing the decoding target region, a disparity vector for the reference image using depth information within a region corresponding to each of the predicted regions on the decoding target region depth and generates the inter-view predicted image for the decoding target region by generating a disparity-compensated image using the disparity vector and the reference image.

8. The image decoding apparatus according to claim 7, further comprising:
a disparity vector storing unit which stores the disparity vector; and
a disparity predicting unit which generates predicted disparity information in a region adjacent to the decoding target region using the stored disparity vector.

9. The image decoding apparatus according to claim 7, further comprising a correction disparity vector unit which sets a correction disparity vector which is a vector for correcting the disparity vector,
wherein the inter-view prediction unit generates the inter-view predicted image by generating a disparity-compensated image using the reference image and a vector which is obtained by correcting the disparity vector using the correction disparity vector.

10. The image decoding apparatus according to claim 9, further comprising:
a correction disparity vector storing unit which stores the correction disparity vector; and
a disparity predicting unit which generates predicted disparity information in a region adjacent to the decoding target region using the stored correction disparity vector.

11. The image decoding apparatus according to claim 4, wherein the decoding target region depth generating unit designates depth information for a pixel of a peripheral integer pixel position as depth information for a pixel of a fractional pixel position within the depth region.

12. An image decoding apparatus which performs decoding while predicting an image between different views using a reference image decoded for a view different from that of a decoding target image and a depth map for the decoding target image when the decoding target image is decoded from encoded data of a multi-view image including images of a plurality of different views, the image decoding apparatus comprising:
a pseudo motion vector setting unit which sets a pseudo motion vector indicating a region on the decoding target image for a decoding target region obtained by dividing the decoding target image;
a decoding target region depth setting unit which sets depth information for a pixel on the depth map corresponding to a pixel within the decoding target region as a decoding target region depth; and
an inter-view prediction unit which generates an inter-view predicted image for the decoding target region for the region indicated by the pseudo motion vector using the reference image assuming that a depth of the region indicated by the pseudo motion vector is the decoding target region depth.

13. The image decoding apparatus according to claim 12, wherein the inter-view prediction unit sets, for each of predicted regions obtained by dividing the decoding target region, a disparity vector for the reference image using depth information within a region corresponding to each of the predicted regions on the decoding target region depth and generates the inter-view predicted image for the decoding target region by generating a disparity-compensated image using the pseudo motion vector, the disparity vector, and the reference image.

14. The image decoding apparatus according to claim 13, further comprising:
a reference vector storing unit which stores a reference vector for the reference image in the decoding target region indicated using the disparity vector and the pseudo motion vector; and
a disparity predicting unit which generates predicted disparity information in a region adjacent to the decoding target region using the stored reference vector.

15. An image encoding method which performs encoding while predicting an image between different views using a reference image encoded for a view different from that of an encoding target image and a depth map for the encoding target image when a multi-view image including images of a plurality of different views is encoded, the image encoding method comprising:
a pseudo motion vector setting step of setting a pseudo motion vector indicating a region on the depth map for an encoding target region obtained by dividing the encoding target image;
a depth region setting step of setting the region on the depth map indicated by the pseudo motion vector as a depth region;
a reference region depth generating step of generating depth information serving as a reference region depth for a pixel of an integer or fractional position within the depth region corresponding to a pixel of an integer pixel position within the encoding target region using depth information of an integer pixel position of the depth map; and
an inter-view prediction step of generating an inter-view predicted image for the encoding target region using the reference region depth and the reference image.

16. An image encoding method which performs encoding while predicting an image between different views using a reference image encoded for a view different from that of an encoding target image and a depth map for the encoding target image when a multi-view image including images of a plurality of different views is encoded, the image encoding method comprising:
a pseudo motion vector setting step of setting a pseudo motion vector indicating a region on the encoding target image for an encoding target region obtained by dividing the encoding target image;
a reference region depth setting step of setting depth information for a pixel on the depth map corresponding to a pixel within the encoding target region as a reference region depth; and
an inter-view prediction step of generating an inter-view predicted image for the encoding target region for the region indicated by the pseudo motion vector using the reference image assuming that a depth of the region indicated by the pseudo motion vector is the reference region depth.

17. An image decoding method which performs decoding while predicting an image between different views using a reference image decoded for a view different from that of a decoding target image and a depth map for the decoding target image when the decoding target image is decoded from encoded data of a multi-view image including images of a plurality of different views, the image decoding method comprising:
a pseudo motion vector setting step of setting a pseudo motion vector indicating a region on the depth map for a decoding target region obtained by dividing the decoding target image;
a depth region setting step of setting the region on the depth map indicated by the pseudo motion vector as a depth region;
a decoding target region depth generating step of generating depth information serving as a decoding target region depth for a pixel of an integer or fractional position within the depth region corresponding to a pixel of an integer pixel position within the decoding target region using depth information of an integer pixel position of the depth map; and
an inter-view prediction step of generating an inter-view predicted image for the decoding target region using the decoding target region depth and the reference image.

18. An image decoding method which performs decoding while predicting an image between different views using a reference image decoded for a view different from that of a decoding target image and a depth map for the decoding target image when the decoding target image is decoded from encoded data of a multi-view image including images of a plurality of different views, the image decoding method comprising:
a pseudo motion vector setting step of setting a pseudo motion vector indicating a region on the decoding target image for a decoding target region obtained by dividing the decoding target image;
a decoding target region depth setting step of setting depth information for a pixel on the depth map corresponding to a pixel within the decoding target region as a decoding target region depth; and
an inter-view prediction step of generating an inter-view predicted image for the decoding target region for the region indicated by the pseudo motion vector using the reference image assuming that a depth of the region indicated by the pseudo motion vector is the decoding target region depth.

19. An image encoding program for causing a computer to execute the image encoding method according to claim 15.

20. An image decoding program for causing a computer to execute the image decoding method according to claim 17.
